(19) United States
(12) Patent Application Publication
(10) Pub. No.: US 2019/0258688 A1
(43) Pub. Date: Aug. 22, 2019

(54) INFORMATION ACQUISITION DEVICE AND INFORMATION ACQUISITION METHOD

(71) Applicant: FUJITSU LIMITED, Kawasaki-shi (JP)

(72) Inventors: Naoki Kobayashi, Hamamatsu (JP); Tomotsugu Mochizuki, Shizuoka (JP)

(73) Assignee: FUJITSU LIMITED, Kawasaki-shi (JP)

(21) Appl. No.: 16/278,565

(22) Filed: Feb. 18, 2019

(30) Foreign Application Priority Data
Feb. 20, 2018 (JP) 2018-028149

(51) Int. Cl. G06F 16/958; H04L 29/08; G06F 16/9535

(52) U.S. Cl. CPC G06F 16/958; G06F 16/9535; H04L 67/22; H04L 67/02

(57) ABSTRACT

An information acquisition device includes one or more memories, and one or more processors the one or more memories and the one or more processors configured to receive first data of a first Web page, when the first data includes a specific character string and a uniform resource locator, perform determination of a value of a layer as a target of search in accordance with a distance between the specific character string and the uniform resource locator, receive second data of a second Web page corresponding to a first layer within the determined value of the layer from the first Web page, and determine whether the second data satisfies a specific condition.

### CROSS-REFERENCE TO RELATED APPLICATION

This application is based upon and claims the benefit of priority of the prior Japanese Patent Application No. 2018-28149, filed on Feb. 20, 2018, the entire contents of which are incorporated herein by reference.

### FIELD

The embodiments discussed herein are related to information acquisition technology.

### BACKGROUND

There is a crawler that searches for links within Web sites and collects Web pages as an example of a tool for obtaining information present on the Web. When Web pages are collected by using a tool such as the crawler or the like, a keyword is used for search from an aspect of narrowing down target Web sites (hereinafter described as “target sites”).

As one aspect, a word, a phrase, or the like that appears with high frequency on the target sites is specified as such a keyword. For example, specified as the keyword is a slang word understood only in a specific community, a jargon used with an intention of concealment from the outside of a specific community, or the like.

When the slang word and the jargon are used on Web sites, the word and the phrase may be used with a meaning different from an original meaning, for example, a meaning according to a dictionary. Therefore, when the slang word or the jargon is specified as a keyword, Web pages of target sites are collected, and besides, sites on which the word or the phrase used as a slang word or a jargon is used with an original meaning are collected other than the target sites. When the sites other than the target sites are thus collected, an amount of data collected by the crawler may be increased. From such an aspect, layers in which links included in Web pages are searched for are limited.

Related technologies are disclosed in Japanese Laid-open Patent Publication No. 2003-132061, Japanese Laid-open Patent Publication No. 2009-37420, and Japanese Laid-open Patent Publication No. 2000-339316, for example.

### SUMMARY

According to an aspect of the embodiments, an information acquisition device includes one or more memories, and one or more processors the one or more memories and the one or more processors configured to receive first data of a first Web page, when the first data includes a specific character string and a uniform resource locator, perform determination of a value of a layer as a target of search in accordance with a distance between the specific character string and the uniform resource locator, receive second data of a second Web page corresponding to a first layer within the determined value of the layer from the first Web page, and determine whether the second data satisfies a specific condition.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of an information acquisition system according to a first embodiment;

FIG. 2 is a diagram illustrating an example of a search setting screen;

FIG. 3 is a diagram illustrating an example of a Web page;

FIG. 4 is a diagram illustrating an example of a Web page search method;

FIGS. 5A to 5C are flowcharts illustrating a procedure of information obtainment processing according to the first embodiment; and

FIG. 6 is a diagram illustrating an example of a hardware configuration of a computer that executes an information acquisition program according to the first embodiment and a second embodiment.

### DESCRIPTION OF EMBODIMENTS

Omission of collection of target sites may occur. For example, when a layer to which links included in Web pages are searched for is limited, the search is discontinued in a stage in which the search reaches the limited layer. Therefore, when there is a target site in a layer deeper than the layer in which the search is discontinued based on the limitation, it is difficult to collect the target site.

An information acquisition program, an information acquisition method, and an information acquisition device according to the present application will hereinafter be described with reference to the accompanying drawings. It is to be noted that present embodiments do not limit the disclosed technology. The embodiments may be combined with each other as appropriate within a scope in which no contradiction of processing contents occurs.

### First Embodiment

[System Configuration]

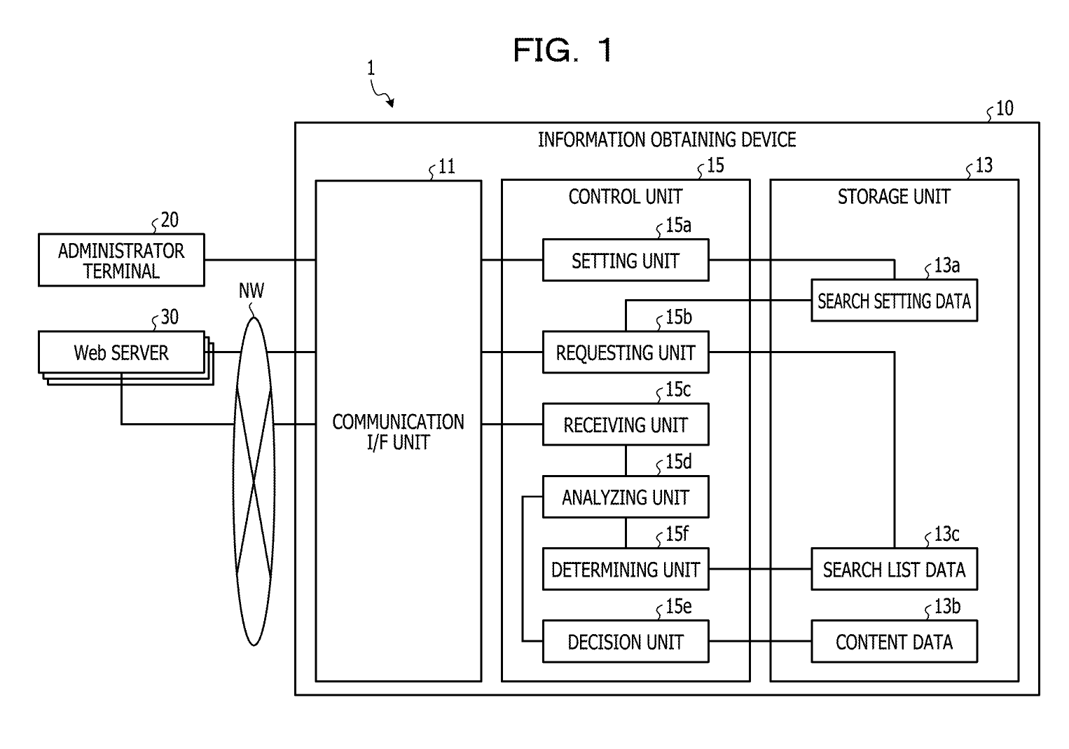

FIG. 1 is a diagram illustrating an example of a configuration of an information acquisition system according to a first embodiment. An information acquisition system 1 illustrated in FIG. 1 provides an information acquisition service that obtains information of target Web sites (hereinafter described as “target sites”) from a Web server 30 present on a network NW such as the Internet, an intranet, or the like.

As illustrated in FIG. 1, the information acquisition system 1 includes an information acquisition device 10 and an administrator terminal 20. A coupling between the information acquisition device 10 and the administrator terminal 20 is established via a local network such as a local area network (LAN), a virtual LAN (VLAN), or the like whether by wire or by radio.

The information acquisition device 10 is a computer that provides the above-described information acquisition service.

As one embodiment, the information acquisition device 10 may be implemented by installing, on a desired computer, an information acquisition program implementing functions corresponding to the above-described information acquisition service as packaged software or online software. For example, the information acquisition device 10 may be implemented on the premises as a server that provides the above-described information acquisition service, or may be implemented as a cloud that provides the above-described information acquisition service by outsourcing.

The administrator terminal 20 corresponds to an example of a client that is provided with the above-described information acquisition service. For example, the administrator terminal 20 is a computer used by an administrator of the information acquisition system 1 or the like. For example, a desktop computer such as a personal computer or the like corresponds to the administrator terminal 20. This is a mere example, and the administrator terminal 20 may be an arbitrary computer such as a laptop computer, a portable terminal device, a wearable terminal, or the like.

Further, as illustrated in FIG. 1, the information acquisition device 10 is coupled to the Web server 30 via the arbitrary network NW. An arbitrary communication network such as the Internet, an intranet, or the like, irrespective of whether the network is a wired network or a wireless network, corresponds to the network NW.

Thus, the information acquisition device 10 functions as a server that provides the above-described information acquisition service, and also has a function of a Web client from an aspect of implementing functions corresponding to the above-described information acquisition service. For example, in the information acquisition device 10, a tool such as a crawler or the like that searches for links within Web sites and collects Web pages is utilized to obtain the information of target sites.

The Web server 30 is a server that provides a Web page in response to a request from the Web client. Kinds of Web sites managed by the Web server 30 are not limited to specific kinds, and may be arbitrary kinds. For example, examples of the Web sites include portal search sites as well as home pages and blogs of individuals, social networking service (SNS) sites, anonymous bulletin boards, and the like.

It is to be noted that while FIG. 1 illustrates the information acquisition device 10 corresponding to the Web client and the Web server 30 as constituent elements of a Web system, the inclusion of constituent elements other than the information acquisition device 10 corresponding to the Web client and the Web server 30 is not precluded. For example, a database server, a file server, a load balancer, and the like may be included as constituent elements of the Web system.

[Configuration of Information Acquisition Device 10]

As illustrated in FIG. 1, the information acquisition device 10 includes a communication interface (I/F) unit 11, a storage unit 13, and a control unit 15. FIG. 1 illustrates solid lines indicating relations between transmission and reception of data, but merely illustrates a minimum of parts for the convenience of description. For example, the input and output of data related to each processing unit is not limited to the illustrated example, and besides, the input and output of data other than that illustrated may be performed, such as data input and output between a processing unit and a processing unit, between a processing unit and data, and between a processing unit and an external device.

The communication I/F unit 11 is an interface that performs communication control with other devices, for example, the administrator terminal 20, the Web server 30, and the like.

As one embodiment, a network interface card such as a LAN card or the like corresponds to the communication I/F unit 11. For example, the communication I/F unit 11 receives input of various settings for making the crawler search from the administrator terminal 20, and presents a result of obtaining the information of a target site to the administrator terminal 20. In addition, the communication I/F unit 11 transmits a Web page request to the Web server 30, and receives a Web page transmitted from the Web server.

The storage unit 13 is a storage device that stores data used for an operating system (OS) executed by the control unit 15 as well as the above-described information acquisition program and various kinds of programs such as application programs, middleware, and the like.

As one embodiment, the storage unit 13 may be implemented as an auxiliary storage device in the information acquisition device 10. For example, a hard disk drive (HDD), an optical disk, a solid state drive (SSD), and the like may be employed as the storage unit 13. Incidentally, the storage unit 13 may be implemented as an auxiliary storage device, and besides, may be implemented as a main storage device in the information acquisition device 10. In this case, various kinds of semiconductor memory elements, for example, a random access memory (RAM) and a flash memory may be employed as the storage unit 13.

The storage unit 13 stores search setting data 13a, content data 13b, and search list data 13c as an example of data used by a program executed by the control unit 15. The storage unit 13 may store other electronic data in addition to these pieces of data. For example, the storage unit 13 may also store account information given to a user using the administrator terminal 20, index data in which Web pages collected from the Web server 30 are indexed, and the like. Incidentally, description of the search setting data 13a, the content data 13b, and the search list data 13c will be made together with description of the control unit 15 that registers or refers to each piece of data.

The control unit 15 is a processing unit that controls the whole of the information acquisition device 10.

As one embodiment, the control unit 15 may be implemented by a hardware processor such as a central processing unit (CPU), a micro processing unit (MPU), or the like. A CPU and an MPU are illustrated as an example of a processor here. However, the control unit 15 may be implemented by an arbitrary processor, irrespective of whether the processor is a general-purpose type or a specialized type, for example, a graphics processing unit (GPU) or a digital signal processor (DSP) as well as a general-purpose computing on graphics processing units (GPGPU). In addition, the control unit 15 may implemented by hard wired logic such as an application specific integrated circuit (ASIC), a field programmable gate array (FPGA), or the like.

The control unit 15 virtually implements the following processing units by expanding the above-described information acquisition program into a work area of a random access memory (RAM) implemented as a main storage device not illustrated.

As illustrated in FIG. 1, the control unit 15 includes a setting unit 15a, a requesting unit 15b, a receiving unit 15c, an analyzing unit 15d, a decision unit 15e, and a determining unit 15f.

The setting unit 15a is a processing unit that performs various settings for search.

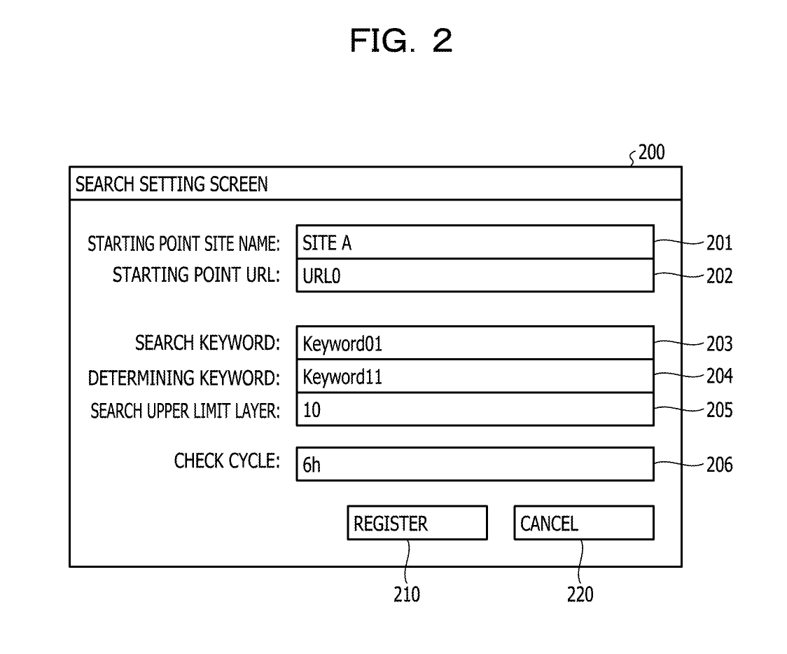

As one aspect, the setting unit 15a may receive various settings related to search from the administrator terminal 20. For example, the setting unit 15a displays a search setting screen 200 illustrated in FIG. 2 on the administrator terminal 20, and thereby receives settings via graphical user interface (GUI) operation on the search setting screen 200.

FIG. 2 is a diagram illustrating an example of a search setting screen. As illustrated in FIG. 2, the search setting screen 200 includes GUI components of text boxes 201 to 206 and buttons 210 and 220. Of the GUI components, the text box 201 may receive, by text input, the name of a Web site as a starting point where the crawler is made to start search. In the following, the Web site as a starting point for starting search may be described as a “starting point site.” In addition, the text box 202 may receive the uniform resource locator (URL) of the starting point site by text input. In the following, the URL of the starting point site may be described as a “starting point URL.” A page, for example, a top page or the like, including a link within the starting point site or a link to another domain is set on the starting point site, for example. In addition, an example of kinds of the starting point site may include various portal sites, and besides, arbitrary kinds of Web sites such as home pages and blogs of individuals, SNS sites, anonymous bulletin boards, and the like. Further, it is possible to set, as the starting point site, the onion router (Tor) site using an anonymity technology of Tor in which an access path to an information source is changed and encryption is performed between nodes included in the access path.

In addition, the text box 203 may receive a keyword specified as a condition for continuing link search, for example, a word, a phrase, or the like, by text input. In the following, the keyword specified as a condition for continuing link search may be described as a “search keyword.” In addition, the text box 204 may receive a keyword specified as a condition for storing a Web page by text input. In the following, the keyword specified as a condition for storing a Web page may be described as a “determining keyword” from an aspect of being used to determine a target site. For example, a word, a phrase, or the like that frequently appears on a target site is specified as the search keyword and the determining keyword. As an example, a slang word understood only in a specific community, a jargon used with an intention of concealment from the outside of a specific community, or the like is specified. These words may be used differently by setting, as the search keyword, a word closer to a nuance of guiding to an object than the object itself targeted on the target site, and setting, as the determining keyword, the object itself targeted on the target site or a jargon thereof.

In addition, the text box 205 may receive the number of layers to be set as an upper limit of searching for links, the number being counted from the starting point site, by text input. In the following, the layer to be set as an upper limit of searching for links, the layer being counted from the starting point site, may be described as a “search upper limit layer.” In addition, the text box 206 may receive, by text input, a cycle of obtaining the information of target sites according to the conditions input via the text boxes 201 to 205. In addition, the button 210 enables the settings input via the text boxes 201 to 206 to be registered. The button 220 enables registration of the settings input via the text boxes 201 to 206 to be canceled.

When an operation on the button 210 is received in a state in which data is input to these text boxes 201 to 206, the data including the items of the name of the starting point site, the starting point URL, the search keyword, the determining keyword, the search upper limit layer, the check cycle, and the like is registered as the search setting data 13a in the storage unit 13. Not all of the above-described items may necessarily be set as the search setting data 13a. For example, a fixed value used by the administrator of the information acquisition system 1 between starting point sites may be set in advance as the search upper limit layer and the check cycle.

The requesting unit 15b is a processing unit that requests a Web page.

As one aspect, triggered when the search setting data 13a is newly registered in the storage unit 13, or when the check cycle included in the registered search setting data 13a has passed, for example, the requesting unit 15b starts to obtain the information of a target site. For example, the requesting unit 15b transmits a hypertext transfer protocol (HTTP) request to the Web server 30 based on the starting point URL included in the search setting data 13a stored in the storage unit 13. This HTTP request includes an HTTP method and a URL specifying the location position of a reference destination document on the Web server 30 specified by a domain name, or in this case the “starting point URL” or the like. Incidentally, in this case, while a case where the request is transmitted according to the starting point URL is illustrated as merely one aspect, the request target is not limited to the Web page of the starting point site. For example, there are cases where the request is transmitted for a link included in the starting point site, or even for the URL of a link within a Web page retrieved by tracing a link of the starting point site.

The receiving unit 15c is a processing unit that receives a Web page.

As one aspect, the receiving unit 15c receives the data of a Web page transmitted from the Web server 30, for example, the data of an HTTP body part, as a response to the HTTP request transmitted by the requesting unit 15b. By thus receiving the data of the HTTP body part included in the response from the Web server 30, it is possible to receive a document described in a markup language, for example, a hypertext markup language (HTML) document. This HTML document may include text, and besides, contents such as an image, sound, a moving image, or the like. Incidentally, the data transmitted and received in the Web system may be HTML documents, and besides, may be other documents, for example, extensible markup language (XML) documents.

The analyzing unit 15d is a processing unit that analyzes a Web page.

As one aspect, the analyzing unit 15d performs text mining of the Web page received by the receiving unit 15c or the like. For example, the analyzing unit 15d detects a character string corresponding to the determining keyword included in the search setting data 13a from the text included in the Web page. In addition, the analyzing unit 15d detects a character string corresponding to the search keyword included in the search setting data 13a from the text included in the Web page. Further, the analyzing unit 15d detects a character string corresponding to the format of a URL embedded as a link, for example, “http: +domain name,” “http: +domain name+path name,” or the like from the text included in the Web page.

The decision unit 15e is a processing unit that determines whether or not the data of the Web page satisfies a specific condition.

As one embodiment, when the Web page is analyzed by the analyzing unit 15d, the decision unit 15e determines whether or not the character string corresponding to the determining keyword is detected from the text included in the Web page. Here, when the Web page includes the determining keyword, it may be recognized that the Web page is highly likely to correspond to a target site. In this case, the decision unit 15e stores the data of the Web page, for example, the source code of the HTML document, the binary data of an image or a moving image embedded in the HTML document, or the like, as the content data 13b in the storage unit 13.

The determining unit 15f is a processing unit that determines the layers of Web pages to be set as search targets according to a distance between a specific character string and a URL included in the Web page.

As one embodiment, when the Web page is analyzed by the analyzing unit 15d, the determining unit 15f determines whether or not the character string corresponding to the search keyword is detected from the text included in the Web page. Here, when the Web page includes the search keyword, the Web page is highly likely to be a target site itself or a Web site where a topic related to the target site appears, and it may therefore be recognized that it is worth continuing search by tracing a link within the Web page. In this case, the determining unit 15f further determines whether or not a character string corresponding to a URL link is detected from the text included in the Web page. Then, when the Web page includes a link, the determining unit 15f additionally registers a URL embedded as the link in the search list data 13c stored in the storage unit 13. The URL thus used for search may be described as a “search URL.” Next, the determining unit 15f calculates, for each search URL, a distance, for example, the number of characters or the like, between the search URL and the search keyword present at a position nearest to the search URL. Incidentally, when the Web page does not include the search keyword, there is an increased possibility of searching for only a Web page having a tenuous relation to a target site even when searching the Web page for a URL link, and therefore subsequent search is discontinued. In addition, when the Web page does not include any URL link, it is difficult to search for a link, and therefore search is discontinued.

After thus calculating the distance between the search keyword and the URL, the determining unit 15f determines a layer to which search is additionally performed from the link of the search URL according to the distance between the search keyword and the search URL. The “layer” referred to here corresponds, as an example, to the number of times of searching for the URL of a link. In the following, the layer to which search is additionally performed from the link of the search URL may be described as an “additional search layer.” In relation to this, a layer reached by searching for links from the starting point site to a newest Web page received by the receiving unit 15c may be described as a “reached layer.”

For example, the determining unit 15f sets the additional search layer to a larger value as the distance between the search keyword and the search URL is decreased, whereas the determining unit 15f sets the additional search layer to a smaller value as the distance between the search keyword and the search URL is increased. For example, the determining unit 15f determines whether or not the distance between the search keyword and the search URL is equal to or less than a threshold value Th1, for example, 100 characters. Then, when the distance between the search keyword and the search URL is not equal to or less than the threshold value Th1, the determining unit 15f determines whether or not the distance between the search keyword and the search URL is equal to or less than a threshold value Th2, for example, 200 characters. Further, when the distance between the search keyword and the search URL is not equal to or less than the threshold value Th2, the determining unit 15f determines whether or not the distance between the search keyword and the search URL is equal to or less than a threshold value Th3, for example, 300 characters. The determinations using these threshold values Th1 to Th3 may classify the distance between the search keyword and the search URL into four patterns such that the distance between the search keyword and the search URL is (A) equal to or less than the threshold value Th1, (B) exceeding the threshold value Th1 and equal to or less than the threshold value Th2, (C) exceeding the threshold value Th2 and equal to or less than the threshold value Th3, and (D) exceeding the threshold value Th3.

In a case where the distance between the search keyword and the search URL corresponds to the pattern (A) among these four patterns, for example, in a case where the distance is equal to or less than the threshold value Th1, the determining unit 15f determines that the layer to which search is additionally performed from the search URL is “3.” In addition, in a case where the distance between the search keyword and the search URL corresponds to the pattern (B), for example, in a case where the distance exceeds the threshold value Th1 and is equal to or less than the threshold value Th2, the determining unit 15f determines that the layer to which search is additionally performed from the search URL is “2.” In addition, in a case where the distance between the search keyword and the search URL corresponds to the pattern (C), for example, in a case where the distance exceeds the threshold value Th2 and is equal to or less than the threshold value Th3, the determining unit 15f determines that the layer to which search is additionally performed from the search URL is “1.” In addition, in a case where the distance between the search keyword and the search URL corresponds to the pattern (D), for example, in a case where the distance exceeds the threshold value Th3, the determining unit 15f determines that the layer to which search is additionally performed from the link of the search URL is “0.”

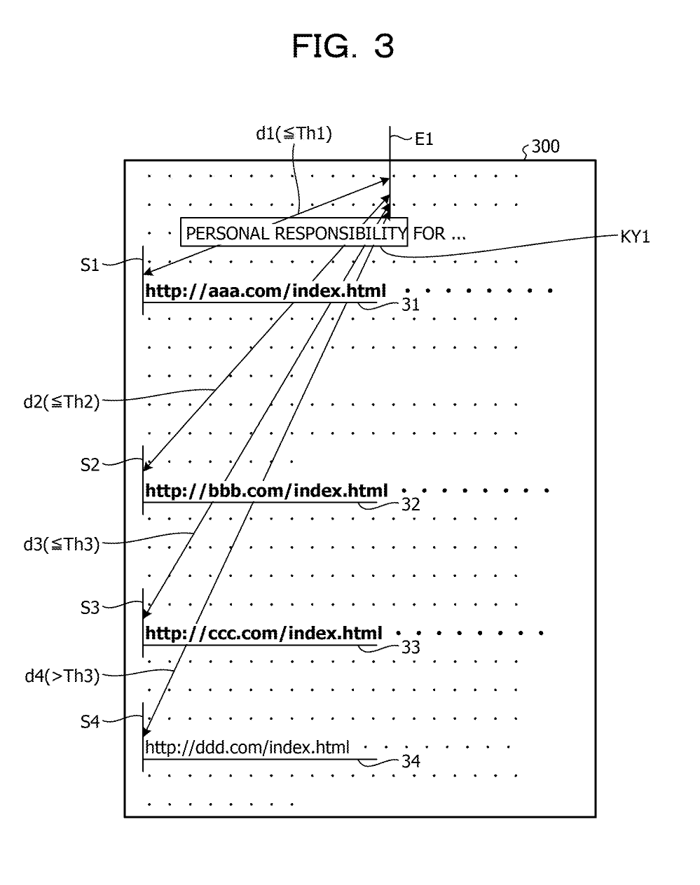

FIG. 3 is a diagram illustrating an example of a Web page. FIG. 3 illustrates a Web page 300 that includes “personal responsibility” as an example of a search keyword KY1 and which has a URL 31, a URL 32, a URL 33, and a URL 34 appearing following the search keyword KY1. Further, FIG. 3 illustrates an example in which a distance d1 between the search keyword KY1 and the URL 31 is less than the threshold value Th1, a distance d2 between the search keyword KY1 and the URL 32 exceeds the threshold value Th1 and is less than the threshold value Th2, a distance d3 between the search keyword KY1 and the URL 33 exceeds the threshold value Th2 and is less than the threshold value Th3, and a distance d4 between the search keyword KY1 and the URL 34 exceeds the threshold value Th3.

In the case where the URLs follow the search keyword KY1 as illustrated in FIG. 3, a distance between a URL and the search keyword KY1 is calculated as follows, as an example. When the distance d1 between the search keyword KY1 and the URL 31 is calculated, for example, calculated as the distance d1 is the number of characters from a position E1 of a last character of the character string of the search keyword KY1 “personal responsibility” appearing on the Web page 300 to a position S1 of a head character of a character string corresponding to the URL 31. When the distance d1 thus corresponds to the above-described pattern (A), a degree of relation between the search keyword KY1 and the URL 31 may be estimated to be high. In this case, additional search for links is allowed in a reached layer at a present point in time, and besides, to a third layer away from the reached layer.

In addition, when the distance d2 between the search keyword KY1 and the URL 32 is calculated, calculated as the distance d2 is the number of characters from the position E1 of the last character of the character string of the search keyword KY1 “personal responsibility” appearing on the Web page 300 to a position S2 of a head character of a character string corresponding to the URL 32. When the distance d2 thus corresponds to the above-described pattern (B), a degree of relation between the search keyword KY1 and the URL 32 may be estimated to be high next to the above-described pattern (A). In this case, additional search for links is allowed in the reached layer at the present point in time, and besides, to a second layer away from the reached layer.

In addition, when the distance d3 between the search keyword KY1 and the URL 33 is calculated, calculated as the distance d3 is the number of characters from the position E1 of the last character of the character string of the search keyword KY1 “personal responsibility” appearing on the Web page 300 to a position S3 of a head character of a character string corresponding to the URL 33. When the distance d3 thus corresponds to the above-described pattern (C), a degree of relation between the search keyword KY1 and the URL 33 may be estimated to be high next to the above-described pattern (B). In this case, additional search for links is allowed from the reached layer at the present point in time to a first layer away from the reached layer.

In addition, when the distance d4 between the search keyword KY1 and the URL 34 is calculated, calculated as the distance d4 is the number of characters from the position E1 of the last character of the character string of the search keyword KY1 “personal responsibility” appearing on the Web page 300 to a position S4 of a head character of a character string corresponding to the URL 34. When the distance d4 thus corresponds to the above-described pattern (D), a degree of relation between the search keyword KY1 and the URL 33 may be estimated to be not as high as those of the above-described patterns (A) to (C). In this case, additional search for links from the reached layer at the present point in time is not allowed.

Incidentally, while FIG. 3 illustrates an example in which the number of characters present between the search keyword and a URL is calculated as an example of the distance between the search keyword and the URL, the data amount, for example, the number of bytes or the like, of a character string present between the search keyword and the URL may also be calculated as the distance. In addition, FIG. 3 illustrates the case where the URLs appear following the search keyword. However, in a case where the URLs precede the search keyword, it is possible to calculate, as the distance, the number of characters from the position of a last character of the character string corresponding to the URL 32, as an example, to the position of a head character of the character string of the search keyword.

From the additional search layer and the reached layer thus determined, the determining unit 15f calculates a layer in which link search is planned to be ended. In the following, the layer in which link search is planned to be ended may be described as a “planned end layer.” Here, as an example, the determining unit 15f calculates the above-described planned end layer by adding the additional search layer to the reached layer, but does not permit a value exceeding the search upper limit layer included in the search setting data 13a as the planned end layer. For example, when the addition value of the reached layer and the additional search layer exceeds the search upper limit layer, the determining unit 15f sets the planned end layer to the same value as the search upper limit layer. The determining unit 15f thereafter registers the reached layer and the planned end layer at the present point in time in association with a search URL added to the search list data 13c. At this time, when the planned end layer of the search URL is shallower than the planned end layer of the immediately preceding search URL, the planned end layer of the immediately preceding search URL may be taken over as the planned end layer of the search URL in question. In addition, in the case where the distance corresponds to the pattern (D), for example, in the case where the distance exceeds the threshold value Th3, the planned end layer of the immediately preceding search URL is automatically taken over as the planned end layer of the search URL in question. In this case, the planned end layer of the immediately preceding search URL and the reached layer are registered in association with the search URL added to the search list data 13c.

Thereafter, the determining unit 15f determines whether or not the reached layer is less than the planned end layer of the search URL, for example, whether or not “Reached Layer<Planned End Layer.” At this time, when Reached Layer<Planned End Layer, the determining unit 15f determines whether or not the reached layer is less than the search upper limit layer included in the search setting data 13a, for example, “Reached Layer<Search Upper Limit Layer.” Then, when “Reached Layer<Planned End Layer” and “Reached Layer<Search Upper Limit Layer,” it is determined that there is room for searching a layer farther than the reached layer for the search URL. When “Reached Layer=Planned End Layer” or “Reached Layer=Search Upper Limit Layer,” on the other hand, it is determined that there is no room for searching a layer farther than the reached layer for the search URL. In this case, a flag that prohibits the continuation of the search is set to the search URL.

For each search URL thus embedded as a link within the Web page, the planned end layer of the search URL is set according to the distance between the search URL and the search keyword, and thereafter an entry of data associating the reached layer and the planned end layer with each search URL is additionally registered in the search list data 13c. Thereafter, while the inclusion of the search keyword and a search URL within a Web page is set as a condition for continuing search, the obtainment of a Web page is repeated by issuing a Web page request based on a search URL included in the search list data 13c, for example, a search URL by which search is not performed yet and the continuation of search is not prohibited until the reached layer becomes equal to either the planned end layer or the search upper limit layer. It is thereby possible to search for Web pages having deep relation to a target site until the reached layer becomes the planned end layer or the search upper limit layer. Further, Web pages identified as target sites may be stored by storing, as the content data 13b, the data of the Web pages including the determining keyword among Web pages.

The Web pages thus stored as the content data 13b may be disclosed to the administrator terminal 20. For example, index data in which the data of the Web pages included in the content data 13b is indexed may be used to output the data of Web pages on which a search keyword specified by the administrator terminal 20 is hit. In addition, a search list in which the search URLs included in the search list data 13c are listed may be output to the administrator terminal 20.

[Example of Search]

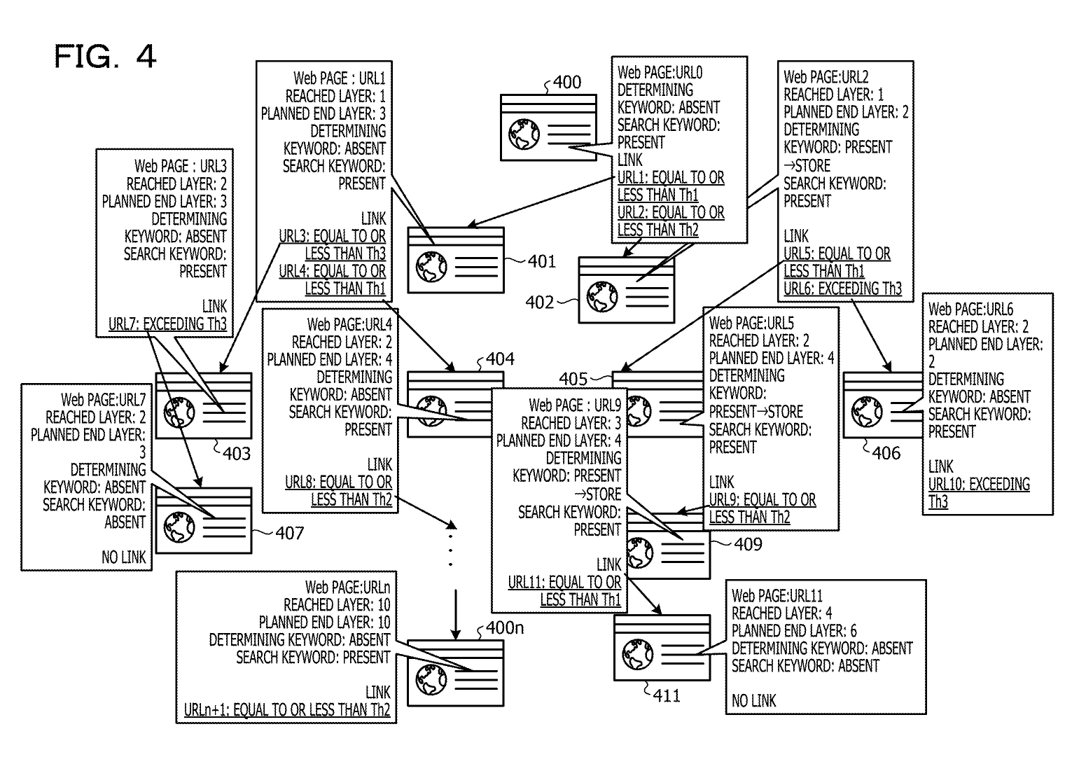

FIG. 4 is a diagram illustrating an example of a Web page search method. FIG. 4 illustrates, in a schematic form, a process of search from the starting point site via links until an end of the search according to the search setting data 13a in which “URL0” is set as the starting point URL and the search upper limit layer is set to “10.” As illustrated in FIG. 4, the search is started with a Web page 400 specified by URL0 as a starting point. For example, an HTTP request specifying URL0 is transmitted, and the Web page 400 is thereby collected as a response to the HTTP request. The Web page 400 does not include the determining keyword, and is therefore not stored. On the other hand, the Web page 400 includes the search keyword, and includes URL1 and URL2.

The distance between the search keyword and URL1 of these URLs is equal to or less than the threshold value Th1. In this case, “3” is set to the additional search layer, and therefore the planned end layer is determined as “3” by a sum of the reached layer “0” and the additional search layer “3.” As a result, an entry of data associating the reached layer “0” and the planned end layer “3” with the search URL “URL1” is added to the search list data 13c. In addition, the distance between the search keyword and URL2 is equal to or less than the threshold value Th2. In this case, “2” is set to the additional search layer, and therefore the planned end layer is determined as “2” by a sum of the reached layer “0” and the additional search layer “2.” As a result, an entry of data associating the reached layer “0” and the planned end layer “2” with the search URL “URL2” is added to the search list data 13c.

When the entry of the search URL “URL1” is selected from the entries thus added to the search list data 13c, an HTTP request specifying URL1 is transmitted, and a Web page 401 is thereby collected as a response to the HTTP request. The Web page 401 does not include the determining keyword, and is therefore not stored. On the other hand, the Web page 401 includes the search keyword, and includes URL3 and URL4.

The distance between the search keyword and URL3 of these URLs is equal to or less than the threshold value Th3. In this case, “1” is set to the additional search layer. In this case, the planned end layer is determined as “2” by a sum of the reached layer “1” and the additional search layer “1.” However, the planned end layer “3” of immediately preceding URL1 is larger. Thus, the planned end layer “3” of immediately preceding URL1 is taken over as the planned end layer of URL3. As a result, an entry of data associating the reached layer “1” and the planned end layer “3” with the search URL “URL3” is added to the search list data 13c. In addition, the distance between the search keyword and URL4 is equal to or less than the threshold value Th1. In this case, “3” is set to the additional search layer, and therefore the planned end layer is determined as “4” by a sum of the reached layer “1” and the additional search layer “3.” As a result, an entry of data associating the reached layer “1” and the planned end layer “4” with the search URL “URL4” is added to the search list data 13c.

When the entry of the search URL “URL3” is selected from the entries thus added to the search list data 13c, an HTTP request specifying URL3 is transmitted, and a Web page 403 is thereby collected as a response to the HTTP request. The Web page 403 does not include the determining keyword, and is therefore not stored. On the other hand, the Web page 403 includes the search keyword, and includes URL7. The distance between the search keyword and URL7 exceeds the threshold value Th3. In this case, “0” is set to the additional search layer. In this case, the planned end layer “3” of immediately preceding URL3 is taken over as the planned end layer of URL7. As a result, an entry of data associating the reached layer “2” and the planned end layer “3” with the search URL “URL7” is added to the search list data 13c.

Next, when the entry of the search URL “URL7” added to the search list data 13c is selected, an HTTP request specifying URL7 is transmitted, and a Web page 407 is thereby collected as a response to the HTTP request. The Web page 407 does not include the determining keyword, and is therefore not stored. Further, the Web page 407 does not include the search keyword either. Hence, search for Web pages at lower levels than the Web page 407 is not performed, and search for Web pages at lower levels than the Web page 407 is discontinued.

In addition, when the entry of the search URL “URL4” is selected from the entries added to the search list data 13c, an HTTP request specifying URL4 is transmitted, and a Web page 404 is thereby collected as a response to the HTTP request. The Web page 404 does not include the determining keyword, and is therefore not stored. On the other hand, the Web page 404 includes the search keyword, and includes URL8. The distance between the search keyword and URL8 is equal to or less than the threshold value Th2. In this case, “2” is set to the additional search layer, and therefore the planned end layer is determined as “4” by a sum of the reached layer “2” and the additional search layer “2.” As a result, an entry of data associating the reached layer “2” and the planned end layer “4” with the search URL “URL8” is added to the search list data 13c.

As illustrated in FIG. 4, Web pages are collected until the reached layer reaches the search upper limit layer in a case where search is performed according to the entry of the search URL “URL8” thus added to the search list data 13c on a search continuation condition that Web pages at lower levels than the Web page 404 include the search keyword and search URLs within the Web pages. For example, the reached layer reaches the search upper limit layer “10” in a stage in which a Web page 400n is collected as a response to an HTTP request specifying URLn. The Web page 400n does not include the determining keyword, and is therefore not stored. On the other hand, the Web page 400n includes the search keyword, and includes URLn+1. The distance between the search keyword and URLn+1 is equal to or less than the threshold value Th2. Thus, “2” is set to the additional search layer. However, the reached layer has reached the search upper limit layer “10.” In this case, an entry of data associating the reached layer “10,” the planned end layer “10,” and a flag prohibiting the continuation of search with the search URL “URLn+1” is added to the search list data 13c. This flag prohibits search for Web pages at lower levels than the Web page 400n, and search for Web pages at lower levels than the Web page 400n is discontinued.

When the entry of the search URL “URL2” is selected from the entries added to the search list data 13c, on the other hand, an HTTP request specifying URL2 is transmitted, and a Web page 402 is thereby collected as a response to the HTTP request. The Web page 402 includes the determining keyword. The data of the Web page 402 is therefore stored as content data 13b. Further, the Web page 402 includes the search keyword, and includes URL5 and URL6.

The distance between the search keyword and URL5 of these URLs is equal to or less than the threshold value Th1. In this case, “3” is set to the additional search layer. In this case, the planned end layer is determined as “4” by a sum of the reached layer “1” and the additional search layer “3.” As a result, an entry of data associating the reached layer “1” and the planned end layer “4” with the search URL “URL5” is added to the search list data 13c. In addition, the distance between the search keyword and URL6 exceeds the threshold value Th3. In this case, “0” is set to the additional search layer. Thus, the planned end layer “2” of immediately preceding URL2 is taken over as the planned end layer of URL6. As a result, an entry of data associating the reached layer “1” and the planned end layer “2” with the search URL “URL6” is added to the search list data 13c.

When the entry of the search URL “URL5” is selected from the entries thus added to the search list data 13c, an HTTP request specifying URL5 is transmitted, and a Web page 405 is thereby collected as a response to the HTTP request. The Web page 405 includes the determining keyword. Thus, the data of the Web page 405 is stored as content data 13b. Further, the Web page 405 includes the search keyword, and includes URL9. The distance between the search keyword and URL9 is equal to or less than the threshold value Th2. In this case, “2” is set to the additional search layer, and therefore the planned end layer is determined as “4” by a sum of the reached layer “2” and the additional search layer “2.” As a result, an entry of data associating the reached layer “2” and the planned end layer “4” with the search URL “URL9” is added to the search list data 13c.

Next, when the entry of the search URL “URL9” added to the search list data 13c is selected, an HTTP request specifying URL9 is transmitted, and a Web page 409 is thereby collected as a response to the HTTP request. The Web page 409 includes the determining keyword. Thus, the data of the Web page 409 is stored as content data 13b. Further, the Web page 409 includes the search keyword, and includes URL11. The distance between the search keyword and URL11 is equal to or less than the threshold value Th1. In this case, “3” is set to the additional search layer, and therefore the planned end layer is determined as “6” by a sum of the reached layer “3” and the additional search layer “3.” As a result, an entry of data associating the reached layer “3” and the planned end layer “6” with the search URL “URL11” is added to the search list data 13c.

Then, when the entry of the search URL “URL11” added to the search list data 13c is selected, an HTTP request specifying URL11 is transmitted, and a Web page 411 is thereby collected as a response to the HTTP request. The Web page 411 does not include the determining keyword, and is therefore not stored. Further, the Web page 411 includes neither the search keyword nor a URL. Hence, though the planned end layer of URL11 of the Web page 411 is set to “6,” search for Web pages at lower levels than the Web page 411 is not performed, and search for Web pages at lower levels than the Web page 411 is discontinued.

In addition, when the entry of the search URL “URL6” is selected from the entries added to the search list data 13c, an HTTP request specifying URL6 is transmitted, and a Web page 406 is thereby collected as a response to the HTTP request. The Web page 406 does not include the determining keyword. On the other hand, the Web page 406 includes the search keyword, and includes URL10. However, the distance between the search keyword and URL10 exceeds the threshold value Th3. In this case, “0” is set to the additional search layer. Therefore, the planned end layer “2” of immediately preceding URL6 is taken over as the planned end layer of URL10. As a result, an entry of data associating the reached layer “2,” the planned end layer “2,” and a flag prohibiting the continuation of search with the search URL “URL10” is added to the search list data 13c. This flag prohibits search for Web pages at lower levels than the Web page 406, and search for Web pages at lower levels than the Web page 406 is discontinued.

As a result of performing search as described above, the data of the Web page 402, the Web page 405, and the Web page 409 may be stored as an example of target sites. Further, URL0 to URL11, URLn, and URLn+1 included in the search list data 13c may be listed and output as a search list.

[Flow of Processing]

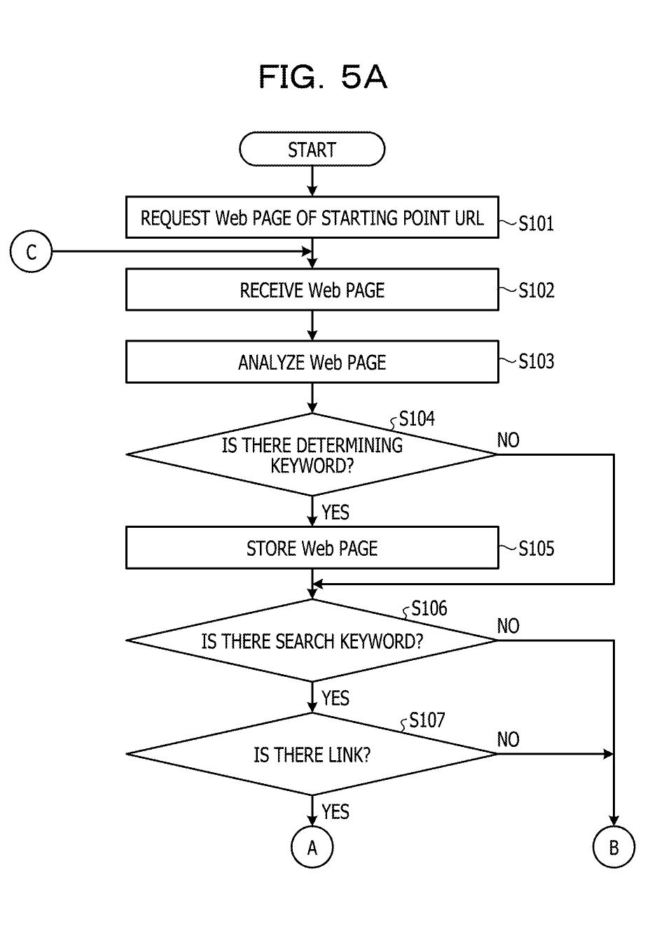

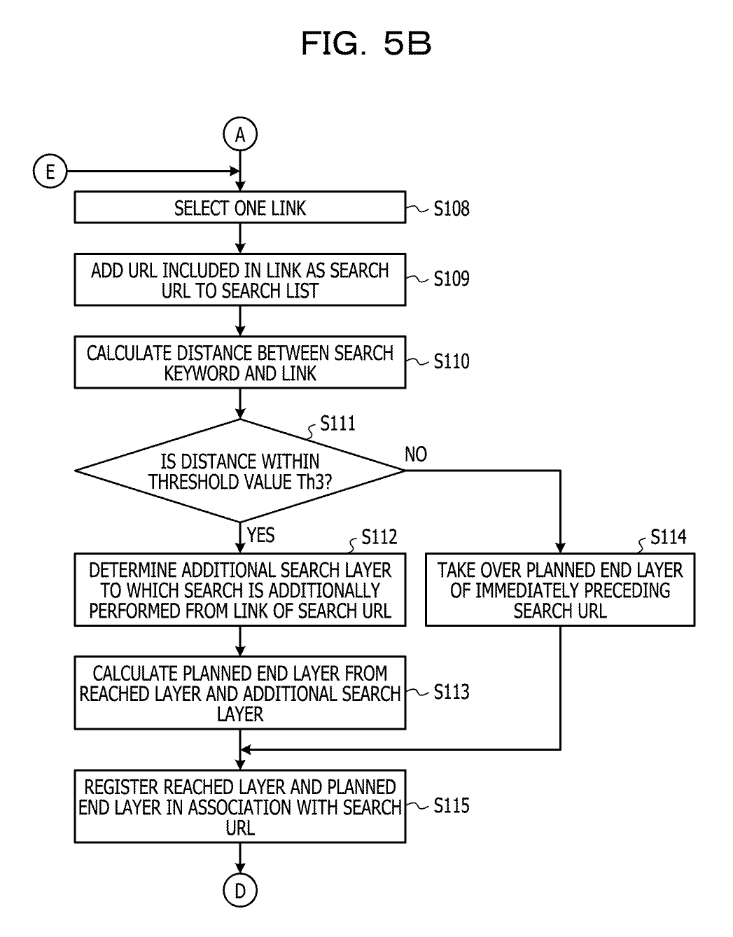

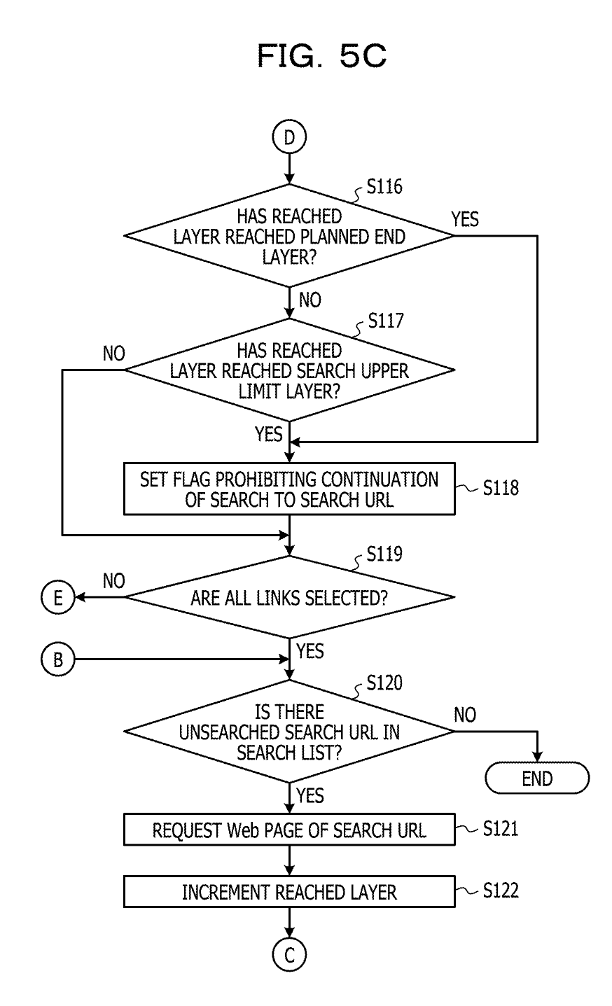

FIGS. 5A to 5C are flowcharts illustrating a procedure of information obtainment processing according to the first embodiment. This processing is performed, for example, when the search setting data 13a is newly registered in the storage unit 13 or when the check cycle included in the registered search setting data 13a has passed. Incidentally, at a time of a start of the processing, a reached layer register retaining the value of the reached layer is set to an initial value, for example, “0.”

As illustrated in FIG. 5A, the requesting unit 15b transmits an HTTP request to the Web server 30 based on the starting point URL included in the search setting data 13a stored in the storage unit 13 (step S101). Next, the receiving unit 15c receives the data of a Web page transmitted from the Web server 30 as a response to the HTTP request transmitted in step S101 (step S102). Then, the analyzing unit 15d performs analysis such as text mining or the like of the Web page received in step S102 (step S103).

Thereafter, the decision unit 15e determines whether or not the character string corresponding to the determining keyword is detected from text included in the Web page received in step S102 as a result of step S103 (step S104).

Here, when the Web page includes the determining keyword (Yes in step S104), it may be recognized that the Web page is highly likely to correspond to a target site. In this case, the decision unit 15e stores the data of the Web page received in step S102, for example, the source code of an HTML document, the binary data of an image or a moving image embedded in the HTML document, or the like, as content data 13b in the storage unit 13 (step S105). Incidentally, when the Web page does not include the determining keyword (No in step S104), the processing of step S105 is skipped.

Then, the determining unit 15f determines whether or not the character string corresponding to the search keyword is detected from the text included in the Web page received in step S102 as a result of step S103 (step S106).

Here, when the Web page includes the search keyword (Yes in step S106), the Web page is highly likely to be a target site itself, or a Web site on which a topic related to the target site appears, and it may therefore be recognized that it is worth continuing search by tracing a link within the Web page. In this case, the determining unit 15f further determines whether or not a character string corresponding to a URL link is detected from the text included in the Web page received in step S102 (step S107).

Incidentally, when the Web page does not include the search keyword (No in step S106), there is an increased possibility of searching for only a Web page having tenuous relation to the target site even when searching the Web page for a URL link, and therefore subsequent search is discontinued. In addition, when the Web page does not include any URL link (No in step S107), it is difficult to search for a link, and therefore search is discontinued. In these cases, the processing proceeds to step S120 illustrated in FIG. 5C.

When the Web page includes links (step S107), the determining unit 15f selects one of URLs embedded as the links, as illustrated in FIG. 5B (step S108). Next, the determining unit 15f additionally registers the URL selected in step S108 as a search URL in the search list data 13c stored in the storage unit 13 (step S109).

Thereafter, the determining unit 15f calculates a distance, for example, the number of characters or the like, between the URL selected in step S108 and the search keyword present at a position nearest to the URL (step S110). Next, the determining unit 15f determines whether or not the distance between the search keyword and the search URL is equal to or less than the threshold value Th3 (step S111).

At this time, when the distance between the search keyword and the search URL is equal to or less than the threshold value Th3 (Yes in step S111), the determining unit 15f determines the additional search layer to which search is additionally performed from the link of the search URL according to the distance between the search keyword and the search URL (step S112). Then, the determining unit 15f calculates the planned end layer in which link search is planned to be ended based on the reached layer stored in the reached layer register not illustrated and the additional search layer (step S113).

When the distance between the search keyword and the search URL is not equal to or less than the threshold value Th3 (No in step S111), on the other hand, the determining unit 15f automatically takes over the planned end layer of an immediately preceding search URL (including the starting point URL) as the planned end layer of the search URL in question (step S114).

Thereafter, the determining unit 15f registers the reached layer stored in the reached layer register not illustrated and the planned end layer calculated in step S113 or the planned end layer taken over in step S114 in the entry of the search URL added to the search list data 13c in step S109 (step S115).

Then, the determining unit 15f determines whether or not the reached layer has reached either the planned end layer of the search URL or the search upper limit layer, for example, whether “Reached Layer=Planned End Layer” or “Reached Layer=Search Upper Limit Layer” (step S116 and step S117).

At this time, when the reached layer has reached either the planned end layer of the search URL or the search upper limit layer (Yes in step S116 or Yes in step S117), it is determined that there is no room for searching for a layer farther than the reached layer for the search URL. In this case, the determining unit 15f sets a flag prohibiting the continuation of search to the search URL (step S118). Incidentally, when the reached layer has reached neither the planned end layer of the search URL nor the search upper limit layer (No in step S116 and No in step S117), the processing of step S118 is skipped.

Thereafter, the processing from the above-described step S108 to the above-described step S118 is repeatedly performed until all of the URLs embedded as links in the Web page are selected (No in step S119).

Then, until the search list data 13c no longer includes an unsearched search URL to which a flag prohibiting the continuation of search is not set (Yes in step S120), the processing proceeds to step S102 after performing the processing of step S121 below and the processing of step S122 below. For example, the requesting unit 15b overwrites and updates the value stored in the reached layer register not illustrated with the value of the reached layer associated with an unsearched search URL included in the search list data 13c, and transmits an HTTP request to the Web server 30 based on the unsearched search URL included in the search list data 13c (step S121). Then, the requesting unit 15b increments the reached layer stored in the reached layer register not illustrated by one (step S122). The processing thereafter proceeds to step S102 to repeat the processing from step S102 to step S119.

The processing is thereafter ended when the search list data 13c no longer includes an unsearched search URL to which a flag prohibiting the continuation of search is not set (No in step S120).

[One Aspect of Effect]

As described above, when a Web page includes the character string of a keyword for narrowing down target sites and a URL link, the information acquisition device 10 according to the present embodiment determines a layer to which search is additionally performed from the URL link according to a distance between the character string and the URL link. It is therefore possible, for example, to continue search for links within Web pages in a case of a short distance between the keyword and the URL, and, on the other hand, to discontinue search for links within Web pages in a case of a long distance between the keyword and the URL. It is accordingly possible to continue search when there is a strong possibility of a link within a Web page corresponding to a target site, and, on the other hand, to discontinue search when there is a small possibility of a link within a Web page corresponding to the target site. Hence, the information acquisition device 10 according to the present embodiment may suppress omission of collection of target sites. Further, the information acquisition device 10 according to the present embodiment may suppress collection of sites other than target sites, and may therefore also suppress an increase in amount of collected data.

### Second Embodiment

An embodiment of the disclosed device has been described thus far. However, the present technology may be carried out in various different forms other than the foregoing embodiment. Accordingly, another embodiment included in the present technology will be described in the following.

[Concrete Example of Use Case]

The information acquisition device 10 according to the foregoing first embodiment can, for example, be applied to cases where illegal sites and harmful sites are collected and a search list is generated in which search URLs of the illegal sites and the harmful sites are listed. As an example, in a case where the information of sites for selling illegal drugs is to be obtained, top pages of various bulletin board sites may be set as the starting point site. Further, at least one or a combination of “personal responsibility,” “sales site,” and “handing-over procedure” may be set as the search keyword. In addition, a word such as “narcotic,” “drug,” or the like, and besides, a jargon such as “ice,” “vegetable,” or the like may be set as the determining keyword. In addition, in a case where the information of sites selling forged identification cards is to be obtained, top pages of various bulletin board sites may be set as the starting point site. Further, at least one or a combination of “personal responsibility,” “account,” and “handling” may be set as the search keyword. In addition, a word such as forgery or the like may be set as the determining keyword.

[Search Keyword]

In the foregoing first embodiment, a case is illustrated in which the inclusion of the search keyword in a Web page is a condition for continuing link search. However, it is possible to extend the scope of the search keyword. For example, it is possible to set the determining keyword also as the search keyword, and continue link search when a Web page includes either the search keyword or the determining keyword. In this case, as a keyword from which a distance to a URL is calculated, either the search keyword or the determining keyword nearest to the URL may be used.

[Distribution and Integration]

In addition, the respective constituent elements of each device illustrated in the figures may not necessarily need to be physically configured as illustrated in the figures. For example, concrete forms of distribution and integration of each device are not limited to those illustrated in the figures, and the whole or a part of each device may be configured so as to be distributed and integrated functionally or physically in arbitrary units according to various kinds of loads, usage conditions, or the like. For example, the setting unit 15a, the requesting unit 15b, the receiving unit 15c, the analyzing unit 15d, the decision unit 15e, or the determining unit 15f may be coupled as a device external to the information acquisition device 10 via a network. In addition, separate devices may each include the setting unit 15a, the requesting unit 15b, the receiving unit 15c, the analyzing unit 15d, the decision unit 15e, or the determining unit 15f, be network-coupled to each other, and cooperate with each other, to thereby implement functions of the above-described information acquisition device 10. In addition, separate devices may each include the whole or a part of the search setting data 13a, the content data 13b, or the search list data 13c stored in the storage unit, be network-coupled to each other, and cooperate with each other, to thereby implement functions of the above-described information acquisition device 10.

[Information Acquisition Program]

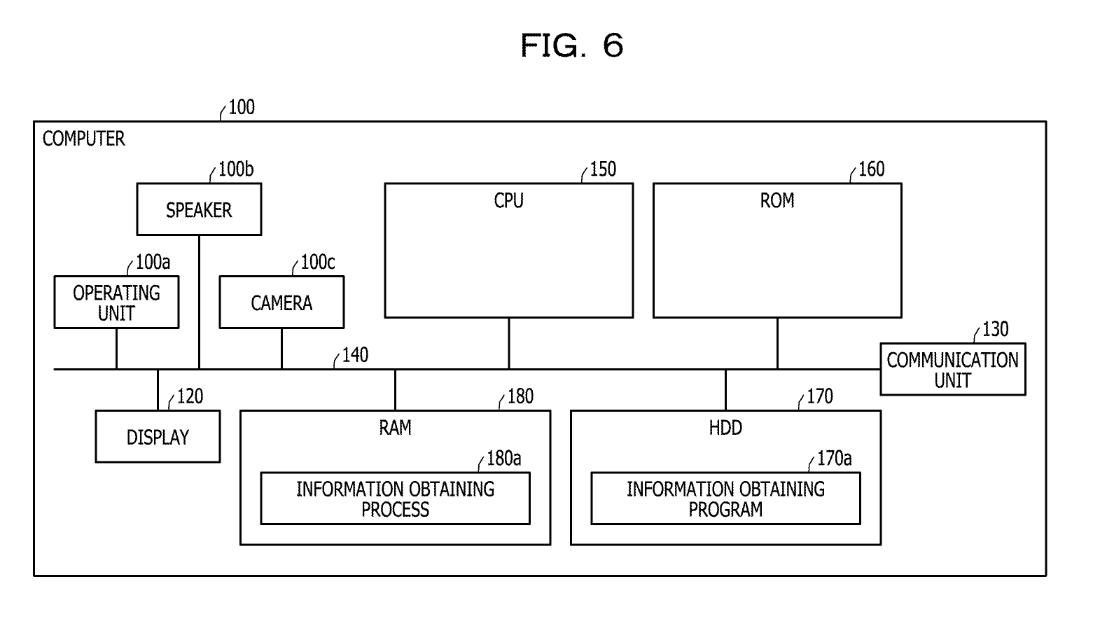

In addition, various kinds of processing described in the foregoing embodiment may be implemented by executing a program prepared in advance on a computer such as a personal computer, a workstation, or the like. Accordingly, in the following, referring to FIG. 6, description will be made of an example of a computer that executes an information acquisition program having functions similar to those of the foregoing embodiment.

FIG. 6 is a diagram illustrating an example of a hardware configuration of a computer that executes an information acquisition program according to the first embodiment and the second embodiment. As illustrated in FIG. 7, a computer 100 includes an operating unit 110a, a speaker 110b, a camera 110c, a display 120, and a communicating unit 130. The computer 100 further includes a CPU 150, a read-only memory (ROM) 160, an HDD 170, and a RAM 180. These units 110 to 180 are coupled to one another via a bus 140.

As illustrated in FIG. 6, the HDD 170 stores an information acquisition program 170a including a plurality of instructions to exert functions similar to those of the setting unit 15a, the requesting unit 15b, the receiving unit 15c, the analyzing unit 15d, the decision unit 15e, and the determining unit 15f illustrated in the foregoing first embodiment. The information acquisition program 170a may be integrated or divided as with the respective constituent elements of the setting unit 15a, the requesting unit 15b, the receiving unit 15c, the analyzing unit 15d, the decision unit 15e, and the determining unit 15f illustrated in FIG. 1. For example, the HDD 170 may store all of the data illustrated in the foregoing first embodiment, or, may store data used for processing.

Under such an environment, the CPU 150 reads the information acquisition program 170a from the HDD 170, and then expands the information acquisition program 170a into the RAM 180. As a result, as illustrated in FIG. 6, the information acquisition program 170a functions as an information acquisition process 180a. The information acquisition process 180a expands various kinds of data read from the HDD 170 into an area assigned to the information acquisition process 180a in a storage area of the RAM 180, and performs various kinds of processing using the expanded various kinds of data. For example, an example of processing performed by the information acquisition process 180a includes the processing illustrated in FIG. 5A to 5C or the like. Incidentally, in the CPU 150, all of the processing units illustrated in the foregoing first embodiment may operate, or, a processing unit corresponding to processing to be performed may virtually implement.

Incidentally, the above-described information acquisition program 170a may not necessarily need to be stored on the HDD 170 or in the ROM 160 from the beginning. For example, the information acquisition program 170a is stored on a “portable physical medium” such as a flexible disk, or a so-called floppy disk (FD), a compact disc (CD)-ROM, a digital versatile disc (DVD) disk, a magneto-optical disk, an integrated circuit (IC) card, or the like that is inserted into the computer 100. The computer 100 may then obtain the information acquisition program 170a from these portable physical media, and execute the information acquisition program 170a. In addition, the information acquisition program 170a may be stored in advance in another computer, a server device, or the like coupled to the computer 100 via a public circuit, the Internet, a LAN, a wide area network (WAN), or the like, and the computer 100 may obtain the information acquisition program 170a from these devices and execute the information acquisition program 170a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information acquisition device comprising:
one or more memories; and
one or more processors coupled to the one or more memories and the one or more processors configured to
receive first data of a first Web page,
when the first data includes a specific character string and a uniform resource locator, perform determination of a value of a layer as a target of search in accordance with a distance between the specific character string and the uniform resource locator,
receive second data of a second Web page corresponding to a first layer within the determined value of the layer from the first Web page, and
determine whether the second data satisfies a specific condition.

2. The information acquisition device according to claim 1, wherein
the distance is based on at least one of a number of characters present between the specific character string and the uniform resource locator and a data amount of characters present between the specific character string and the uniform resource locator.

3. The information acquisition device according to claim 1, wherein
the first layer is determined on the basis of a number of links via which the information acquisition device accesses the second Web page from the first Web page.

4. The information acquisition device according to claim 1, wherein
the determination includes determining that the value of the layer is a first value when the distance is no more than a first threshold value.

5. The information acquisition device according to claim 4, wherein
the determination includes determining that the value of the layer is a second value smaller than the first value when the distance is more than the first threshold value and no more than a second threshold value.

6. The information acquisition device according to claim 1, wherein
the specific condition is a condition that another specific character string is included in the second data.

7. The information acquisition device according to claim 1, wherein
the processor is further configured to store the first Web page and the second Web page in the one or more memories in association with each other when the second Web page satisfies the specific condition.

8. An information acquisition method executed by a computer, the information acquisition method comprising:
receiving first data of a first Web page;
when the first data includes a specific character string and a uniform resource locator, performing determination of a value of a layer as a target of search in accordance with a distance between the specific character string and the uniform resource locator;
receiving second data of a second Web page corresponding to a first layer within the determined value of the layer from the first Web page; and
determining whether the second data satisfies a specific condition.

9. The information acquisition method according to claim 8, wherein
the distance is based on at least one of a number of characters present between the specific character string and the uniform resource locator and a data amount of characters present between the specific character string and the uniform resource locator.

10. The information acquisition method according to claim 8, wherein
the first layer is determined on the basis of a number of links via which the computer accesses the second Web page from the first Web page.

11. The information acquisition method according to claim 8, wherein
the determination includes determining that the value of the layer is a first value when the distance is no more than a first threshold value.

12. The information acquisition method according to claim 11, wherein
the determination includes determining that the value of the layer is a second value smaller than the first value when the distance is more than the first threshold value and no more than a second threshold value.

13. The information acquisition method according to claim 8, wherein
the specific condition is a condition that another specific character string is included in the second data.

14. The information acquisition method according to claim 8, further comprising:
storing the first Web page and the second Web page in a memory in association with each other when the second Web page satisfies the specific condition.

15. A non-transitory computer-readable medium storing instructions executable by one or more computers, the instructions comprising:
one or more instructions for receiving first data of a first Web page;
one or more instructions for performing, when the first data includes a specific character string and a uniform resource locator, determination of a value of a layer as a target of search in accordance with a distance between the specific character string and the uniform resource locator;
one or more instructions for receiving second data of a second Web page corresponding to a first layer within the determined value of the layer from the first Web page; and
one or more instructions for determining whether the second data satisfies a specific condition.
